(19) United States
(12) Patent Application Publication
(10) Pub. No.: US 2025/0310245 A1
(43) Pub. Date: Oct. 2, 2025

(54) RELAY DEVICE AND PROGRAM

(71) Applicant: DENSO CORPORATION, Kariya-city (JP)

(72) Inventor: Taichi ITAGAWA, Kariya-city (JP)

(21) Appl. No.: 19/045,721

(22) Filed: Feb. 5, 2025

(30) Foreign Application Priority Data
Mar. 28, 2024 (JP) 2024-053294

(51) Int. Cl. H04L 45/52; G07C 5/08; H04L 12/40; H04L 45/00; H04L 45/302

(52) U.S. Cl. CPC H04L 45/52; G07C 5/0808; H04L 12/40006; H04L 45/22; H04L 45/302; H04L 2012/40215

(57) ABSTRACT

A relay device or a non-transitory computer-readable storage medium storing a program relays data between a plurality of electronic devices, performs mutual conversion between a first protocol used for communication with a first electronic device and a second protocol used for communication with a second electronic device, selects one of a plurality of routes to be used according to at least one of a characteristic of a communication message or a situation of the plurality of routes, and transmits the selected route to the second electronic device.

### CROSS REFERENCE TO RELATED APPLICATION

The present application claims the benefit of priority from Japanese Patent Application No. 2024-053294 filed on Mar. 28, 2024. The entire disclosure of the above application is incorporated herein by reference.

### TECHNICAL FIELD

The present disclosure relates to a technology for relaying between networks with different protocols.

### BACKGROUND

In an in-vehicle system, Ethernet is used to connect an external tool such as a diagnostic device to a relay device, and Ethernet and CAN may be used together to connect multiple electronic control units (hereinafter, referred to as ECUs) to the relay device. The CAN and Ethernet are registered trademarks. An example of diagnostic communication in Ethernet is DoIP, and an example of diagnostic communication in CAN is DoCAN.

The DoIP is capable of transmitting large amounts of data at high speed, but is characterized by poor response when transmitted via TCP/IP. On the other hand, the DoCAN has the advantage that it can transmit small amounts of data at one time, but has good responsiveness.

When performing diagnostic communication with an ECU connected to a CAN using an external tool, it is necessary to perform conversion between DoIP and DoCAN, and due to the speed difference between DoIP and CAN, the DoCAN communication speed is limited by the CAN communication speed.

A comparative technology, which uses multiple communication paths including CAN and Ethernet and switches the communication paths depending on the security required for communication and the like, has been known.

### SUMMARY

A relay device or a non-transitory computer-readable storage medium storing a program relays data between a plurality of electronic devices, performs mutual conversion between a first protocol used for communication with a first electronic device and a second protocol used for communication with a second electronic device, selects one of a plurality of routes to be used according to at least one of a characteristic of a communication message or a situation of the plurality of routes, and transmits the selected route to the second electronic device.

### BRIEF DESCRIPTION OF THE DRAWINGS

The above and other features and advantages of the present disclosure will become more apparent from the following detailed description made with reference to the accompanying drawings, in which like parts are designated by like reference numbers.

FIG. 1 is a block diagram showing a configuration of an in-vehicle system.

FIG. 2 is an explanatory diagram showing a protocol configuration.

FIG. 3 is a flowchart of a route selection process in the first embodiment.

FIG. 4 is a flowchart of a delay transmission process.

FIG. 5 is a sequence diagram showing an operation when a diagnostic message is transmitted from an external tool to an ECU.

FIG. 6 is a flowchart of a route selection process in a second embodiment.

FIG. 7 is an explanatory diagram illustrating the contents of a determination condition table used in a third embodiment.

FIG. 8 is a flowchart of a route selection process in a third embodiment.

### DETAILED DESCRIPTION

However, as a result of detailed study by the inventor, it has been found that the comparative technology is a technology for switching between multiple types of communication paths with different protocols set up on the same transmission line, and that it cannot be applied to networks in which the protocol used for each transmission line is fixed.

One example of the present disclosure provides a technology for efficiently utilizing each transmission line in a relay device to which multiple transmission lines using different protocols are connected.

One example embodiment of the present disclosure is a relay device that relays data between multiple electronic devices, and includes a protocol conversion unit and a route selection unit. The protocol conversion unit is configured to perform conversion between a first protocol used for communication with a first electronic device and a second protocol used for communication with a second electronic device. The route selection unit relays a communication message from a first electronic device, the message being addressed to a second electronic device connected via multiple physical or logical paths. During the relay, the route selection unit is configured to select which of the multiple routes to use according to at least one of the characteristics of the communication message and the status of the multiple routes, and to perform transmission to the second electronic device using the selected route.

According to this configuration, it is possible to efficiently utilize multiple transmission lines using different protocols. One aspect of the present disclosure is a program for causing a computer to function as a relay device that relays data between multiple electronic devices. The relay device includes a protocol conversion unit and a route selection unit.

By executing such a program, it is possible to obtain the same effect as the relay device described above.

Hereinafter, embodiments of the present disclosure will be described with reference to drawings.

### 1. First Embodiment

### 1-1. Configuration

An in-vehicle system 1 of the present embodiment is mounted on a vehicle. The vehicle may have an automated driving function in addition to a manual driving function. The vehicle may be a hybrid vehicle having an engine and an electric motor as a traveling source. The vehicle is not limited to the vehicle having the automated driving function or the hybrid vehicle, but may be a vehicle having only a manual driving function, or a vehicle having only an engine or only an electric motor as the traveling source. Hereinafter, the vehicle equipped with the in-vehicle system 1 will be simply referred to as a vehicle.

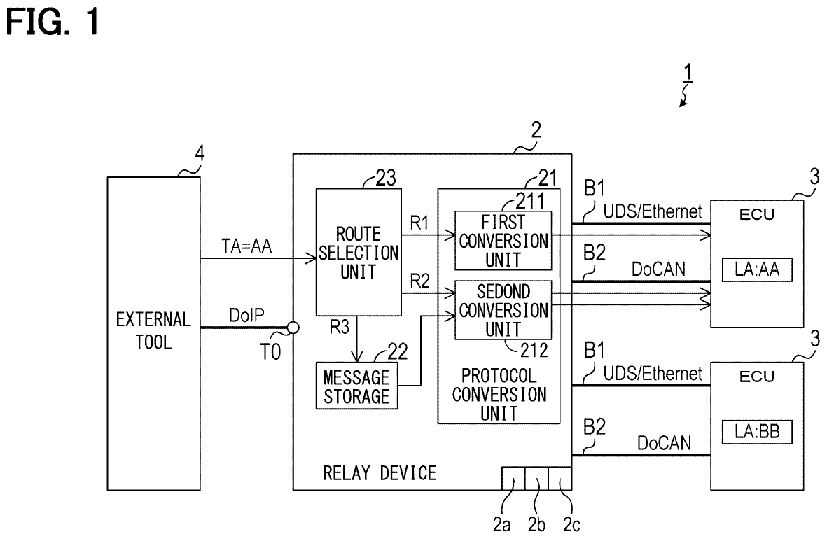

As shown in FIG. 1, the in-vehicle system 1 includes a relay device 2 and multiple electronic control units (hereinafter, referred to as ECUs) 3. The ECU is an abbreviation for Electronic Control Unit. The relay device 2 has an external connection terminal T0 to which an external tool 4 is attached and detached. The relay device 2 is connected to multiple ECUs 3 via two physical transmission lines B1 and B2, respectively. The transmission lines B1 and B2 use different protocols for communication.

Hereinafter, the protocol used for communication between the relay device 2 and the external tool 4 is referred to as a first protocol, and the protocol used for communication between the relay device 2 and the ECU 3 is referred to as a second protocol. That is, in the present embodiment, there are two types of second protocols.

Further, the protocols used for diagnostic communication between the relay device 2 and the external tool 4, and between the relay device 2 and the ECU 3, are referred to as higher protocols. Furthermore, a protocol at a lower layer than the higher protocol, which is used for a connection to enable communication by the higher protocol between the relay device 2 and the external tool 4, and between the relay device 2 and the ECU 3, is referred to as a lower protocol.

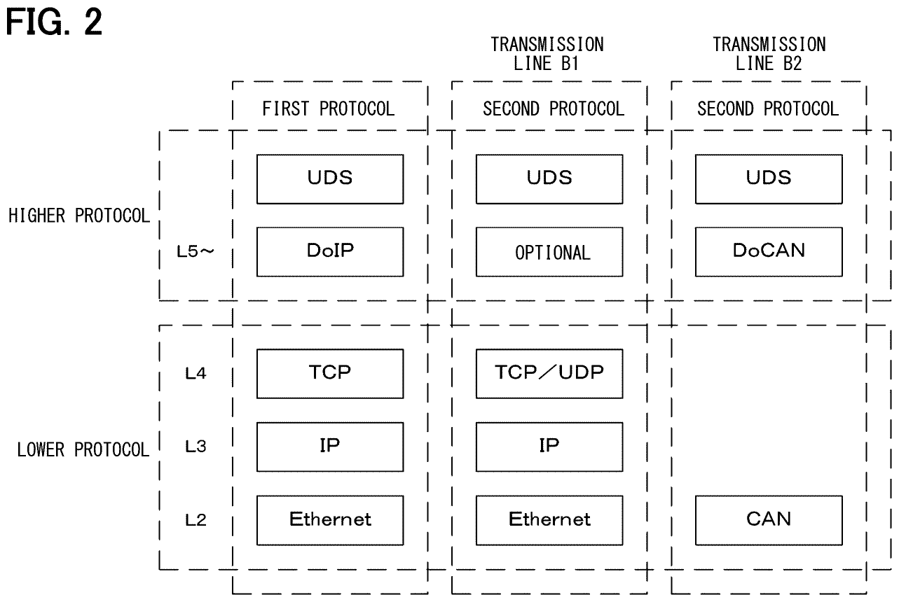

As shown in FIG. 2, in the present embodiment, the first higher protocol is UDS and DoIP, and the first lower protocol is TCP, IP, and Ethernet. The Ethernet is a registered trademark. The UDS is an abbreviation for Unified Diagnostic Services, which is a unified diagnostic service for automobiles standardized by ISO14229. The DoIP is an abbreviation for Diagnostics over Internet Protocol, and is an Ethernet-based diagnostic protocol standardized by ISO13400.

The second protocol used in the transmission line B1 connecting the relay device 2 and each ECU 3 has a lower protocol of TCP/UDP, IP, and Ethernet, and a higher protocol of UDS and any other protocol. Hereinafter, the transmission line B1 is also referred to as a UDS/Ethernet bus.

The second protocol used in the transmission line B2 connecting the relay device 2 and each ECU 3 has a higher protocol of UDS and DoCAN, and a lower protocol of CAN. The CAN is a registered trademark and is an abbreviation for Controller Area Network. The DoCAN is an abbreviation for Diagnostic communication over Controller Area Network, and is a CAN-based diagnostic protocol standardized by ISO15765. Hereinafter, the transmission line B2 will also be referred to as a DoCAN bus.

The expression of “optional” in the higher protocol of the UDS/Ethernet bus B1 means that any protocol can be used as the protocol connecting the UDS and the lower protocol. In the present embodiment, one or more UDS messages are packaged in data transmitted and received in a frame of a lower protocol transmitted and received via the UDS/Ethernet bus B1.

As shown in FIG. 1, the relay device 2 is an electronic control unit mainly including a microcomputer including a CPU 2a, a ROM 2b, a RAM 2c, and the like. Various functions of the microcomputer are implemented by the CPU 2a executing programs stored in a non-transitory tangible storage medium. In this example, the ROM 2b corresponds to a non-transitory tangible storage medium that stores a program. Further, by executing this program, a method corresponding to the program is executed. Note that partial or all of the functions executed by the CPU 2a may be implemented by a hardware circuit, such as one or more ICs. Further, the number of the microcomputers constituting the relay device 2 may be one or more.

### 1-2. Functional Configuration of Relay Device

The functional configuration of the relay device 2 will be described. Each of the multiple ECUs 3 is assigned a logical address LA for identifying the device that is the target of diagnostic communication in the higher protocol. In the present embodiment, of the two ECUs 3, one is assigned LA=AA, and the other is assigned LA=BB.

The relay device 2 includes a protocol conversion unit 21, a message storage 22, and a route selection unit 23 as functional blocks that are implemented by the CPU 2a or the like executing a program stored in the ROM 2b or the like.

The protocol conversion unit 21 performs protocol conversion on a diagnostic message transmitted and received between the external tool 4 and the ECU 3. The protocol conversion unit 21 includes a first conversion unit 211 and a second conversion unit 212.

The first conversion unit 211 generates one or more UDS messages from a DoIP message received from the external tool 4. The first conversion unit 211 further generates a UDS/Ethernet message by combining one or more UDS messages into one within the data length range allowed by the UDS/Ethernet bus B1, and transmits the UDS/Ethernet message to the ECU 3 via the UDS/Ethernet bus B1. In addition, the first conversion unit 211 generates the DoIP message to be transmitted to the external tool 4 based on the UDS/Ethernet message received from the ECU 3 via the UDS/Ethernet bus B1.

The second conversion unit 212 generates one or more DoCAN messages based on the DoIP message received from the external tool 4, and transmits the generated messages to the ECU 3 via the DoCAN bus B2. The second conversion unit 212 further generates a DoIP message to be transmitted to the external tool 4 based on the DoCAN message received from the ECU 3 via the DoCAN bus B2. The reason why the second conversion unit 212 generates one or more DoCAN messages based on the DoIP message is that the amount of data that can be transmitted in one frame is smaller in the DoCAN message than in the DoIP message. The data length of one frame is a maximum of 8 bytes in CAN, which is a lower protocol of DoCAN, and a maximum of 1500 bytes in Ethernet, which is a lower protocol of DoIP. When the Ethernet supports jumbo frames, the data length of one frame is a maximum of 9216 bytes.

The message storage 22 temporarily stores a diagnostic message (i.e., a DoIP message) received from the external tool 4. The stored diagnostic message is transmitted to the ECU 3 via the protocol conversion unit 21 when a preset transmission condition is satisfied.

The route selection unit 23 selects the route to be used for transmitting the diagnostic message depending on the characteristics of the DoIP message received from the external tool 4 and the communication status of the UDS/Ethernet bus B1 and the DoCAN bus B2, and executes the route selection process and the like, to transmit the message to the ECU 3 using the selected route.

There are first to third routes R1 to R3 as selectable routes. The first route R1 is a route in which the DoIP message is converted into the UDS/Ethernet message by the first conversion unit 211 and transmitted to the ECU 3 using the UDS/Ethernet bus B1. The second route R2 is a route in which the DoIP message is converted into a series of DoCAN messages by the second conversion unit 212 and sequentially transmitted to the ECU 3 via the DoCAN bus B2. The third route R3 is a route in which the DoIP message is temporarily stored in the message storage 22, and when the transmission condition is satisfied, the stored DoIP message is converted into a series of DoCAN messages by the second conversion unit 212 and sequentially transmitted to the ECU 3 using the DoCAN bus B2. In other words, the third route R3 is a route that delays transmission to the ECU 3 by passing through the message storage 22.

Regardless of which of the first to third routes R1 to R3 is used, the same logical address LA is set as the destination address of a diagnostic message addressed to the same ECU 3. In other words, each ECU 3 does not need to prepare the different logical address LA for each route.

The transmission condition may be, for example, an instruction input by a vehicle user to turn off the power supply of the vehicle, and therefore turn off the power supply of the relay device 2. In this case, before the power is actually turned off, the diagnostic message stored in the message storage 22 is transmitted. The transmission condition may be that a situation is detected in which the possibility of communication requiring real-time performance is low.

### 1-2. Route Selection Process

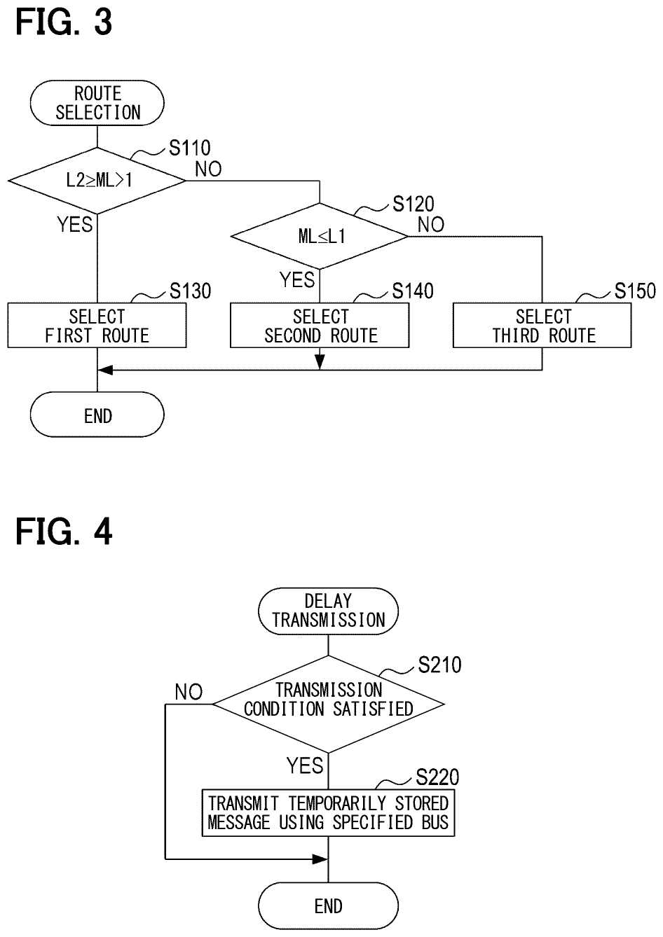

Next, the route selection process executed by the route selection unit 23 will be described with reference to the flowchart of FIG. 3.

The route selection process is started when the relay device 2 receives the DoIP message from the external tool 4. In S110, the route selection unit 23 determines whether the message length ML of the DoIP message received from the external tool 4 is greater than a first specified length L1 and less than or equal to a second specified length L2, i.e., determines whether L2≥ML≥L1 is satisfied. When the route selection unit 23 determines the result is positive, the process proceeds to S130, and when the result is negative, the process proceeds to S120.

In S120, the route selection unit 23 determines whether the message length ML is equal to or less than the first specified length L1, that is, whether ML≤L1 is satisfied. When the route selection unit 23 provides the positive determination, the process proceeds to S140. When the route selection unit 23 provides the negative determination, that is, determination of ML>L2, the process proceeds to S150.

The first specified length L1 is set to a value such that the time required to transfer, to the ECU 3, the DoIP message having the data length equal to or greater than L1 is shorter when using the first route R1 than when using the second route R2. The second specified length L2 is set to a value such that when transfer of the DoIP message having a data length of L2 or more is started via the first route R1, a delay exceeding an allowable value may occur in diagnostic communication with other ECUs 3.

In S130, the route selection unit 23 selects the first route R1 as the transmission route for the DoIP message, executes protocol conversion and transmission using the first route R1, and ends the process. In S140, the route selection unit 23 selects the second route R2 as the transmission route for the DoIP message, executes protocol conversion and transmission using the second route R2, and ends the process.

In S150, the route selection unit 23 selects the third route R3 as the transmission route for the DoIP message. The route selection unit 23 temporarily stores the DoIP message in the message storage 22 so that transmission is performed using the third route R3, and then transmits a response message to the external tool 4 instead of the transmission destination ECU 3, and ends the process.

### 1-3. Delay Transmission Process

The delay transmission process executed by the route selection unit 23 will be described with reference to the flowchart shown in FIG. 4. The delay transmission process is repeatedly executed while the message storage 22 stores an unsent DoIP message.

In S210, the route selection unit 23 determines whether the transmission condition is satisfied. When the transmission condition is satisfied, the process proceeds to S220. When the transmission condition is not satisfied, the process ends.

In S220, the route selection unit 23 reads out the DoIP message temporarily stored in the message storage 22, converts it into a series of DoCAN messages in the second conversion unit 212, and sequentially transmits the messages to the ECU 3 using the DoCAN bus B2, and ends the process.

### 1-4. Operation

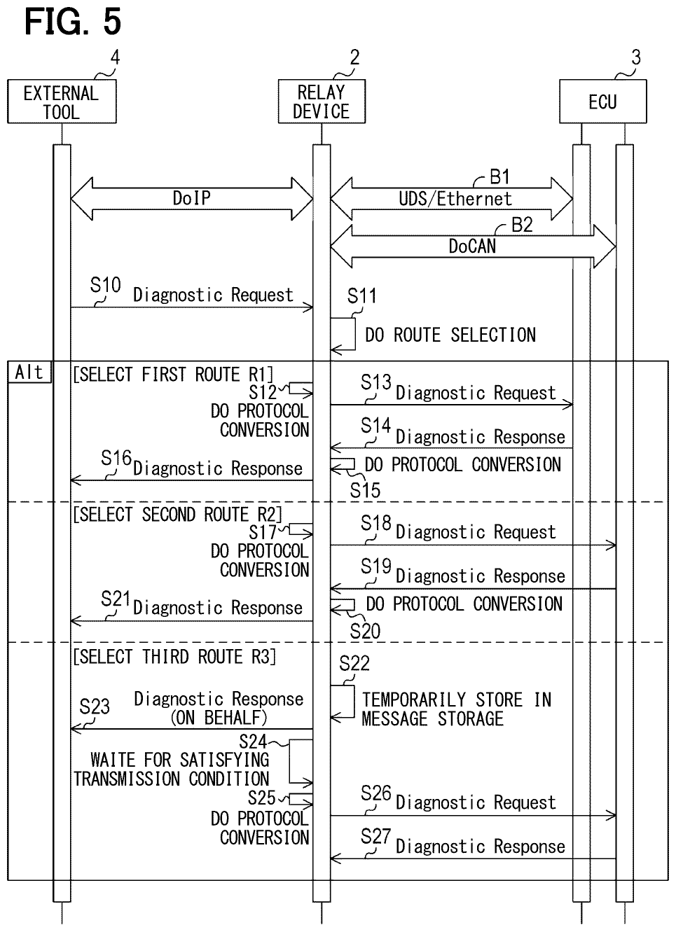

The operation performed when transmitting the diagnostic message from the external tool 4 to the ECU 3 will be described with reference to the sequence diagram shown in FIG. 5.

In S10, the external tool 4 transmits a request message, which is a diagnostic message conforming to DoIP, to the relay device 2. The relay device 2 that has received the request message executes the route selection process in S11.

When the first route R1 is selected as a result of the route selection process, in S11, the relay device 2 executes protocol conversion in the first conversion unit 211 and generates the UDS/Ethernet message (hereinafter, a protocol-converted request message). Then, in S13, the relay device 2 transmits the protocol-converted request message to the ECU 3 via the UDS/Ethernet bus B1. In this case, the request message contains one or more UDS messages packaged together.

In S14, the ECU 3 having received the request message via the UDS/Ethernet bus B1 transmits a response message to the request message to the relay device 2 via the UDS/Ethernet bus B1.

Upon receiving the response message from the ECU 3, the relay device 2 converts the protocol of the received response message from the UDS/Ethernet format to the DoIP format in S15. Then, in S16, the relay device 2 transmits the protocol-converted response message to the external tool 4.

When the second route R2 is selected as a result of the previous route selection process, in S17, the relay device 2 performs protocol conversion in the second conversion unit 212 and generates a series of DoCAN messages (hereinafter, protocol-converted request messages). Then, in S18, the relay device 2 transmits the protocol-converted request message to the ECU 3 via the DoCAN bus B2.

In S19, the ECU 3 having received the request message via the DoCAN bus B2 transmits the response message to the request message to the relay device 2 via the DoCAN bus B2.

Upon receiving the response message from the ECU 3, the relay device 2 converts the protocol of the received response message from the DoCAN format to the DoIP format in S20. Then, in S21, the relay device 2 transmits the protocol-converted response message to the external tool 4.

The processes of S18 to S21 are repeated the same number of times as the number of DoCAN messages generated in S17. When the third route R3 is selected as a result of the previous route selection process, the relay device 2 temporarily stores the received request message (i.e., the DoIP message) in the message storage 22 in S22. Furthermore, in S23, the relay device 2 transmits the response message in the DoIP format to the external tool 4 on behalf of the transmission destination ECU 3. Thereafter, in S24, the relay device 2 waits until the transmission condition is satisfied.

When the transmission condition is satisfied, in S25, the relay device 2 executes protocol conversion in the second conversion unit 212 and generates a series of DoCAN messages (hereinafter, protocol-converted request messages). Then, in S26, the relay device 2 transmits the protocol-converted request message to the ECU 3 via the DoCAN bus B2.

In S27, the ECU 3 having received the request message via the DoCAN bus B2 transmits the response message to the request message to the relay device 2 via the DoCAN bus B2.

In this case, the relay device 2 having received the response message does not transfer the response message to the external tool 4 because it has already transmitted the response message to the external tool 4 by proxy in S23.

The processes of S25 to S27 are repeated the same number of times as the number of DoCAN messages generated in S25.

### 1-5. Correspondence of Terms

In the present embodiment, the external tool 4 corresponds to a first electronic device of the present disclosure, and the ECU 3 corresponds to a second electronic device of the present disclosure. In the present embodiment, the first route R1 and the second route R2 correspond to a physical route of the present disclosure, and the third route R3 corresponds to a logical route and a delay route of the present disclosure. In the present embodiment, the diagnostic messages (i.e., DoIP messages and DoCAN messages) correspond to a communication message of the present disclosure. In the present embodiment, the second specified length L2 corresponds to a specified length of the present disclosure, and the DoCAN bus B2 corresponds to a specified bus of the present disclosure.

### 1-6. Effects

According to a first embodiment described in detail above, the following effects are achieved.

(1a) In a case of relaying the diagnostic message from the external tool 4 to the ECU 3, when the message is a large message with the message length ML with the relation of L2≥ML≥L1, the relay device 2 selects the first route R1 using the UDS/Ethernet bus B1. Further, in the case of a small message, where the message length ML satisfies the relation of ML≤L1, the second route R2 using the DoCAN bus B2 is selected. Accordingly, the relay device 2 can efficiently perform diagnostic communication between the external tool 4 and the ECU 3.

(1 b) In the case of the large message that may affect other communications (in other words, message that satisfies the relation of ML>L2), the relay device 2 selects the third route R3 for temporarily storing the diagnostic message. Then, when the situation is detected in which there is a low possibility of affecting other communications, transmission to the ECU 3 is executed. Accordingly, by the relay device 2, it is possible to improve the reliability of communication.

(1c) When the third route R3 is used, the relay device 2 returns a response message to the external tool 4 on behalf of the transmission destination ECU 3. Therefore, according to the relay device 2, when communication via the third route R3 is selected, it is possible to prevent the external tool 4 from entering a state of waiting for a reply from the ECU 3 and causing a state where the communication cannot be performed with other ECUs 3. Thereby, it is possible to improve the communication efficiency.

### 2. Second Embodiment

### 2-1. Difference from First Embodiment

The fundamental configuration of a second embodiment is similar to that of the first embodiment. Therefore, the difference therebetween will be described below. The same reference numerals as in the first embodiment denote the same elements, and reference is made to the preceding description.

In the first embodiment described above, the route is selected according to the message length ML of the DoIP message received from the external tool 4. In contrast, the second embodiment differs from the first embodiment in that the route is selected depending on the situation of the transmission lines B1, B2 that connect the relay device 2 and the ECU 3.

### 2-2. Process

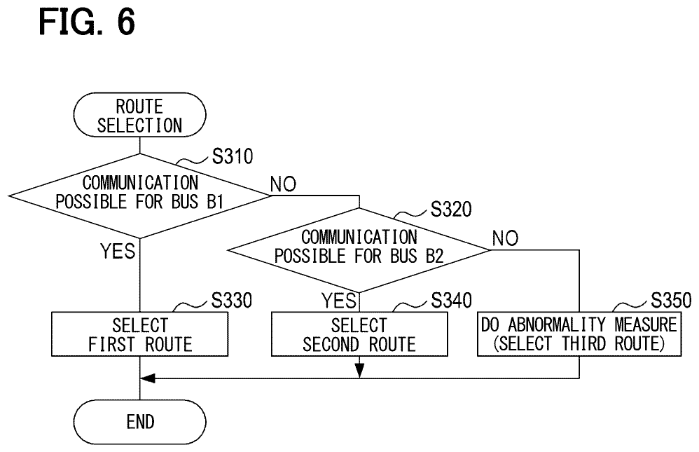

Next, a route selection process executed by the route selection unit 23 of the second embodiment in place of the route selection process of the first embodiment shown in FIG. 3 will be described with reference to a flowchart of FIG. 6.

The route selection process is initiated when the relay device 2 receives the DoIP message from the external tool 4, similarly to the first embodiment. In S310, the route selection unit 23 determines whether the UDS/Ethernet bus B1 is available for communication (in other words, the communication is possible for the UDS/Ethernet bus B1). When it is available for communication, the process proceeds to S330. When it is not available for communication, the process proceeds to S320. To determine whether the UDS/Ethernet bus B1 is available for communication, for example, link down, which is one piece of information provided by an Ethernet driver, may be used. Also, in a network using TCP/IP, an ICMP, which is a protocol used for checking the communication status, may be used. The ICMP is an abbreviation for Internet Control Message Protocol.

In S320, the route selection unit 23 determines whether the DoCAN bus B2 is available for the communication. When it is available for the communication, the process proceeds to S340. When it is not available for the communication, the process proceeds to S350. To determine whether the DoCAN bus B2 is available for the communication, for example, a bus off state, which is one piece of information provided by the CAN driver, may be used.

In S330, the route selection unit 23 selects the first route R1 as the transmission route for the DoIP message, executes protocol conversion and transmission using the first route R1, and ends the process. In S340, the route selection unit 23 selects the second route R2 as the transmission route for the DoIP message, executes protocol conversion and transmission using the second route R2, and ends the process.

In S350, the route selection unit 23 executes an abnormality measure, such as notifying the external tool 4 that communication with the ECU 3 is not possible, and ends the process. The abnormality measure may include a process of temporarily storing the DoIP message in the message storage 22 so that the DoIP message can be transmitted via the third route R3.

In the delay transmission process described with reference to FIG. 4, the transmission condition may include that either the UDS/Ethernet bus B1 or the DoCAN bus B2, which are physical routes, is available for communication. In this case, the DoIP message stored in the message storage 22 may be transmitted to the ECU 3 via the physical route that has become available for communication, after converting the protocol according to the route to be used.

### 2-3. Effects

The second embodiment described above provides the effect (1c) according to the above described first embodiment and the following effect.

(2a) According to the present embodiment, even when either the UDS/Ethernet bus B1 or the DoCAN bus B2 becomes unavailable for communication, the communication with the ECU 3 can be performed. Therefore, it is possible to improve the reliability of communication.

### 3. Third Embodiment

### 3-1. Difference from First Embodiment

Since a basic configuration of a second embodiment is similar to the first embodiment, the difference will be described below. The same reference numerals as in the first embodiment denote the same elements, and reference is made to the preceding description.

In the first and second embodiments described above, the route is selected based on one condition each, that is, the data length or the situation of the transmission lines B1 and B2. In contrast, the third embodiment differs from the first and second embodiments in that the route is selected by combining multiple conditions.

### 3-2. Process

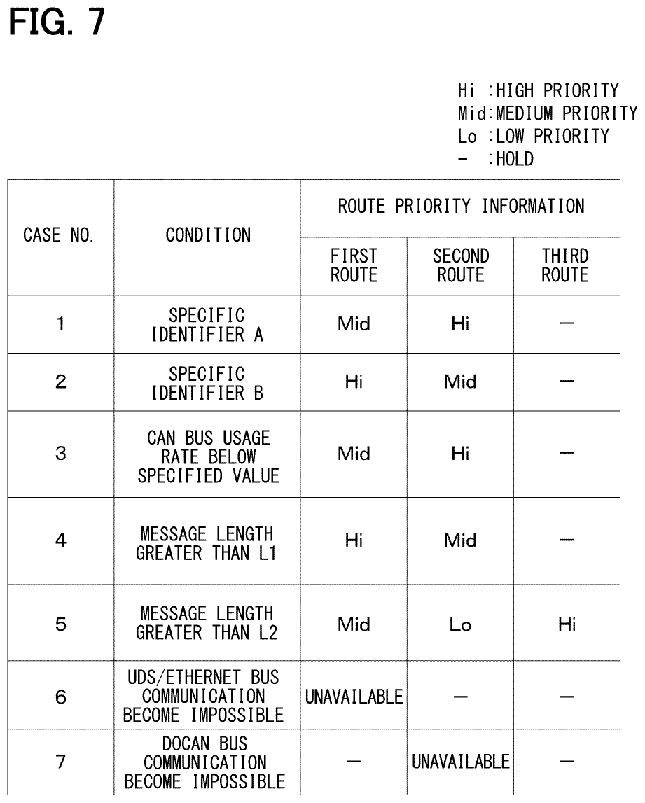

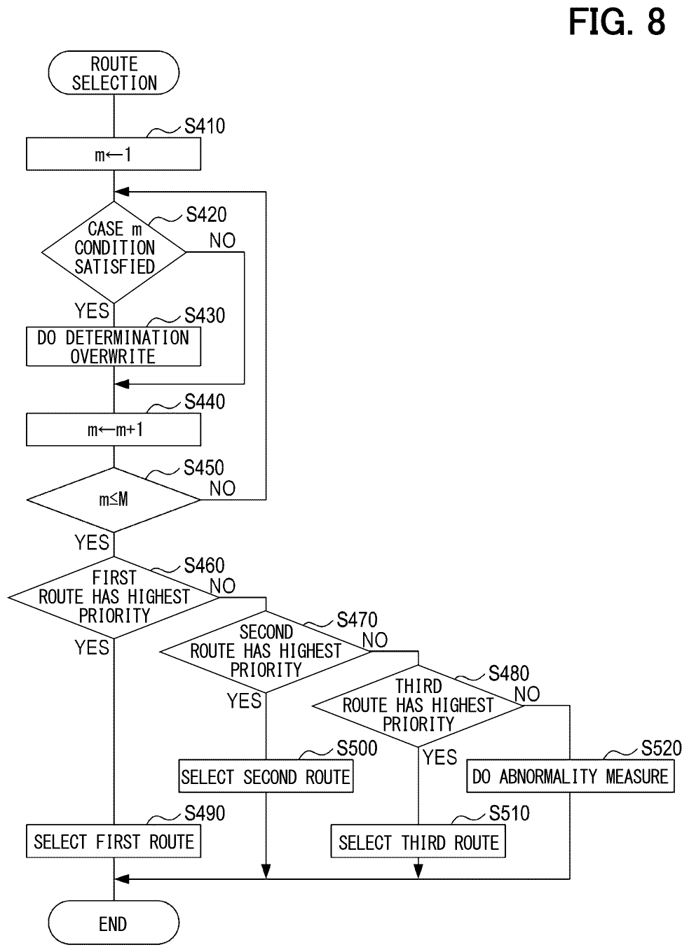

A route selection process executed by the route selection unit 23 of the third embodiment in place of the route selection process of the first embodiment shown in FIG. 3 will be described with reference to a condition determination table of FIG. 7 and a flowchart of FIG. 8.

As shown in FIG. 7, the condition determination table shows, in association with a case number, conditions used for route selection and route priority information indicating the priority of the first route R1, the second route R2, and the third route R3 when the condition is satisfied.

In the present embodiment, a case where seven conditions are used will be described. The condition in case 1 is that a specific identifier is A. The specific identifier may be, for example, a SID used to identify a service in the UDS, or a DID used to identify data in the UDS. The specific identifier may be, other than the SID or DID, a logical address used to identify a device in the UDS, a TCP/UDP port number, an IP address, a MAC address, or the like. When the condition in case 1 is satisfied, the first route R1 is assigned medium priority, the second route R2 is assigned high priority, and the third route R3 is on hold.

The condition in case 2 is that the specific identifier is B. When the condition in case 2 is satisfied, the first route R1 is assigned high priority, the second route R2 is assigned medium priority, and the third route R3 is on hold. The condition in case 3 is that the utilization rate of the CAN bus is equal to or less than a specified value, that is, that the CAN bus is not in a congested state. When the condition in case 3 is satisfied, the first route R1 is assigned medium priority, the second route R2 is assigned high priority, and the third route R3 is on hold.

The condition in case 4 is that the message length ML of the DoIP message received from the external tool 4 is greater than the first specified length L1. The L1 is the same as that described in the first embodiment. When the condition in case 4 is satisfied, the first route R1 is assigned high priority, the second route R2 is assigned medium priority, and the third route R3 is on hold.

The condition in case 5 is that the message length of the DoIP message received from the external tool 4 is greater than the second specified length L2. The L2 is the same as that described in the first embodiment. When the condition in case 5 is satisfied, the first route R1 has the medium priority, the second route R2 has the low priority, and the third route R3 has the high priority.

The condition in case 6 is that the UDS/Ethernet bus B1 is in a situation where the communication is not possible. The determination as to whether the UDS/Ethernet bus B1 is incapable of communication is the same as that described in the second embodiment. When the condition in case 6 is satisfied, the first route R1 cannot be used, and the second route R2 and the third route R3 are on hold.

The condition in case 7 is that the DoCAN bus B2 is in the situation where the communication is not possible. The determination as to whether the DoCAN bus B2 is in the situation where the communication is not possible is similar to that described in the second embodiment. When the condition in case 7 is satisfied, the first route R1 and the third route R3 are reserved, and the second route R2 is unavailable.

The conditions in cases 1 to 7 are arranged so that the smaller the case number, the lower the importance, and the larger the case number, the higher the importance. Each condition is determined in the order of cases 1 to 7. When the condition is satisfied, the route priority information associated with the satisfied condition is overwritten in the priority information register. However, for routes whose priority is on hold, the already written information is not overwritten and is maintained.

As a result of the determination for all cases 1 to 7, one of the first route R1, the second route R2, and the third route R3 is selected according to the information finally indicated in the priority information register. In addition, any route that remains on hold until the end is deemed unavailable. The route that is shown to have the highest priority is then selected.

For example, when cases 4 and 6 are established, the final values of the priority information register are such that the first route R1 is unavailable, the second route R2 is of medium priority, and the third route R3 is unavailable due to being on hold until the end. Therefore, the second route R2 is selected.

The route selection process using the condition determination table will be described with reference to the flowchart of FIG. 8. In S410, the route selection unit 23 sets a parameter m indicating a case number to 1, and initializes the contents of the priority information register to a value indicating the hold state for all routes.

In S420, the route selection unit 23 refers to the condition determination table and determines whether the condition of case m is satisfied. When the route selection unit 23 determines that the condition of case m is satisfied, the process proceeds to S430. When the route selection unit 23 determines that the condition is not satisfied, the process proceeds to S440.

In S430, the route selection unit 23 overwrites the route priority information of case m in the priority information register. In S440, the parameter m indicating the case number is incremented by one.

In S450, the route selection unit 23 determines whether m exceeds the higher limit value M of the case number shown in the condition determination table (i.e., M=7 in this embodiment). In a case of m>M, the process proceeds to S460. In a case of m≤M, the process returns to S420.

In S460, the route selection unit 23 refers to the priority information register and determines whether the first route R1 is set as the highest priority. When the determination is positive, the process proceeds to S490. When the determination is negative, the process proceeds to S370.

In S470, the route selection unit 23 refers to the priority information register and determines whether the second route R2 is set as the highest priority. When the determination is positive, the process proceeds to S500. When the determination is negative, the process proceeds to S480.

In S480, the route selection unit 23 refers to the priority information register and determines whether the third route R3 is set as the highest priority. When the determination is positive, the process proceeds to S510. When the determination is negative, the process proceeds to S520.

In S490, the route selection unit 23 selects the first route R1 as the transmission route for the DoIP message, executes protocol conversion and transmission using the first route R1, and ends the process. In S500, the route selection unit 23 selects the second route R2 as the transmission route for the DoIP message, executes protocol conversion and transmission using the second route R2, and ends the process.

In S510, the route selection unit 23 selects the third route R3 as the transmission route for the DoIP message. The route selection unit 23 further temporarily stores the DoIP message in the message storage 22 so that transmission is performed using the third route R3, and then ends the process.

In S520, the route selection unit 23 executes an abnormality measure, such as notifying the external tool 4 that communication with the ECU 3 is not possible, and ends the process.

### 3-3. Effects

According to the third embodiment described above in detail, in addition to the effects (1a) to (1c) of the first embodiment and the effect (2a) of the second embodiment, the following effect is also obtained.

(3a) Since the route selection is performed by combining multiple conditions, it is possible to implement optimal route selection for various situations.

### 4. Other Embodiments

Although the embodiment of the present disclosure has been described above, the present disclosure is not limited to the above-described embodiments, and various modifications can be made.

(4a) In the above embodiment, frames containing one or more UDS messages are transmitted and received on the UDS/Ethernet bus B1. However, the bus may be configured to store, transmit, and receive one or more messages conforming to a protocol (for example, DoCAN) that is not used in normal Ethernet.

(4b) In the above embodiment, the third route R3 transmits the diagnostic message stored in the message storage 22 to the ECU 3 via the DoCAN bus B2, but may also be configured to transmit the diagnostic message to the ECU 3 via the UDS/Ethernet bus B1. Also, the bus B1 or B2 to be used may be switched depending on certain situations.

(4c) The relay device 2 and the method according to the present disclosure may be achieved by a dedicated computer provided by constituting a processor and a memory programmed to execute one or more functions embodied by a computer program. Alternatively, the relay device 2 and the method according to the present disclosure may be achieved by a dedicated computer provided by constituting a processor with one or more dedicated hardware logic circuits. Alternatively, the relay device 2 and the method according to the present disclosure may be achieved using one or more dedicated computers constituted by a combination of the processor and the memory programmed to execute one or more functions and the processor with one or more hardware logic circuits. The computer program may be stored in a computer-readable non-transitory tangible storage medium as instructions to be executed by a computer. The method for implementing the functions of the respective units included in the relay device 2 does not necessarily need to include software, and all of the functions may be implemented with the use of one or multiple hardware.

(4d) Multiple functions of one component in the embodiments described above may be implemented by multiple components, or one function of one component may be implemented by multiple components. Multiple functions of multiple components may be implemented by one component, or one function implemented by multiple components may be implemented by one component. Part of the configuration of the above embodiment may be omitted. Further, at least part of the configuration of the above-described embodiments may be added to or replaced with the configuration of another embodiment described above.

(4e) In addition to the relay device 2 described above, various features such as a system having the relay device as a component, a program for making a computer function as the relay device 2, a non-transitory tangible storage medium such as a semiconductor memory in which the program is stored, and a data relay method may be provided to implement the present disclosure.

What is claimed is:

1. A relay device configured to relay data between a plurality of electronic devices, the relay device comprising:
a protocol conversion unit configured to perform mutual conversion between a first protocol used for communication with a first electronic device and a second protocol used for communication with a second electronic device; and
a route selection unit configured to, when relaying a communication message from the first electronic device to the second electronic device that is connected to a plurality of routes that are physical or logical and is a transmission destination,
select one of the plurality of routes to be used according to at least one of a characteristic of the communication message or a situation of the plurality of routes, and
transmit the selected route to the second electronic device.

2. The relay device according to claim 1, wherein
the relay device and the second electronic device are connected by a first transmission line and a second transmission line having a communication speed slower than a communication speed of the first transmission line,
the plurality of routes include a first route using the first transmission line and a second route using the second transmission line, and
the route selection unit is configured to
select the first route when a message length of the communication message is equal to or greater than a specified length, and
select the second route when the message length of the communication message is shorter than the specified length.

3. The relay device according to claim 2, wherein
the second protocol applied to the first transmission line includes unified diagnostic services (UDS) and Ethernet (registered trademark), and
the second protocol applied to the second transmission line is configured to include diagnostic communication over controller area network (DoCAN).

4. The relay device according to claim 1, wherein
the route selection unit is configured to
determine whether communication is possible for each of a plurality of transmission lines connected to the second electronic device as a situation of the plurality of routes, and
select, among the plurality of routes, a route using the transmission line with determination that the communication is possible.

5. The relay device according to claim 4, wherein
the route selection unit is configured to use any one of Ethernet link down, an internet control message protocol (ICMP), or a CAN bus off state to determine whether the communication is possible in the plurality of transmission lines.

6. The relay device according to claim 1, further comprising
a message storage configured to temporarily store the communication message,
wherein
the plurality of routes include a logical delay route passing through the message storage,
in a case where relaying the communication message has started,
when delay of a different communication message is likely to exceed an allowable value,
the route selection unit is configured to
select the delay route,
store the communication message in the message storage, and
transmit the communication message stored in the message storage to the second electronic device that is a relay destination at a timing when a transmission condition is satisfied.

7. The relay device according to claim 6, wherein
the transmission condition is to receive an instruction to power off the relay device.

8. The relay device according to claim 6, wherein
the route selection unit is configured to execute a response to the first electronic device instead of the second electronic device that is the relay destination when selecting the delay route.

9. The relay device according to claim 1, wherein
the first protocol is set to include diagnostics over internet protocol (DoIP) and a transmission control protocol (TCP)/internet protocol (IP), or is set to include any one of information of an SID used to identify a service in unified diagnostic services (UDS), a data identifier (DID) used to identify data in the UDS, a logical address used to identify a device in the UDS, a TCP/UDP port number, an IP address, and a media access control (MAC) address.

10. A non-transitory computer-readable storage medium storing a program for causing a computer to:
relay data between a plurality of electronic devices;
perform mutual conversion between a first protocol used for communication with a first electronic device and a second protocol used for communication with a second electronic device; and
when relaying a communication message from the first electronic device to the second electronic device that is connected to a plurality of routes that are physical or logical and is a transmission destination,
select one of the plurality of routes to be used according to at least one of a characteristic of the communication message or a situation of the plurality of routes, and
transmit the selected route to the second electronic device.

11. A relay device configured to relay data between a plurality of electronic devices, the relay device comprising:
a processor; and
a memory coupled to the processor and storing program instructions that when executed by the processor cause the processor to at least:
perform mutual conversion between a first protocol used for communication with a first electronic device and a second protocol used for communication with a second electronic device; and
when relaying a communication message from the first electronic device to the second electronic device that is connected to a plurality of routes that are physical or logical and is a transmission destination,
select one of the plurality of routes to be used according to at least one of a characteristic of the communication message or a situation of the plurality of routes, and
transmit the selected route to the second electronic device.
